(19) United States
(12) Patent Application Publication
(10) Pub. No.: US 2011/0126348 A1
(43) Pub. Date: Jun. 2, 2011

(54) SINGLE-PIECE HIGH RATE FLUSH VALVE ASSEMBLY

(76) Inventors: Chris W. Jeffers, Hebron, CT (US); Matthew J. Siena, Portland, CT (US)

(21) Appl. No.: 12/627,636

(22) Filed: Nov. 30, 2009

(51) Int. Cl. E03D 1/34; B23P 17/04

(52) U.S. Cl. 4/378; 29/428

(57) ABSTRACT

A single-piece flush valve assembly for increasing the flush rate out of a discharge hole in a tank. The kit has an upper portion with an upper cylindrical wall defining an upper bore and a lower portion with a lower cylindrical wall defining a lower bore. The lower bore is smaller than the upper bore. The upper portion defines an inlet and the lower portion defines an outlet. The upper and lower bores are fluidly connected and collectively define a discharge conduit that extends from the inlet to the outlet. The lower portion is inserted into a discharge hole of like or substantially similar diameter. A flapper is swingable relative to the valve assembly from a closed position abutting the inlet to an open position raised from the inlet. The upper bore of greater relative diameter to the lower bore increases the rate of flow out the discharge hole.

### BACKGROUND OF THE DISCLOSURE

The present disclosure relates to flush tanks, and more particularly, to the valve assembly associated with toilet bowl flush tanks.

Both consumer and institutional toilets can be ordered in a wide variety of sizes, styles, and colors. Regardless of this wide variety of available options, most toilets are operated by a valve assembly installed at the discharge hole of the flush tank. Some discharge holes have a smaller diameter than others, resulting in a slower rate of flushing when the valve is opened. A toilet with a slower flush rate is less effective at flushing debris, leaving it more susceptible to plumbing blockages. One common “smaller” size of toilet tank discharge hole has a two inch diameter.

### SUMMARY

There is a need for a valve assembly for installation into flush tanks with small (for example, two inch diameter) discharge holes that increases the rate of flushing when the valve is opened. The present disclosure is directed to a single piece valve assembly for installation in smaller discharge holes that increases the flush flow rate of water when the valve is opened. Installing the disclosed flush valve assembly allows one to increase the inlet opening of a tank discharge hole without replacing the tank and/or plumbing, resulting in an increased flow rate out of the tank when flushed.

According to one disclosed embodiment, a flush valve assembly has an upper portion and a lower portion. The upper portion has a generally cylindrical upper wall that defines an upper bore and an inlet with a sloped open face. The upper bore has a diameter D₁. A generally L-shaped passage extends from a lateral opening in the upper wall. A lower radial shoulder extends inwardly from the upper wall opposite the inlet. The radial shoulder defines a substantially circular transition opening. The lower portion has a generally cylindrical lower wall that is sized to mate with a discharge hole of a particular diameter. The lower wall extends from the transition opening substantially coaxial to the upper wall. The lower wall defines a lower bore and an outlet. The lower bore has a diameter D₂ that is less than D₁. The upper and lower bores are fluidly connected through the transition opening and collectively define a discharge conduit.

In another embodiment of the flush valve assembly, an upper wall defines an upper bore with a diameter D₁ and an inlet with a sloped open face. A radial shoulder extends inwardly from the upper wall opposite the inlet. The radial shoulder is substantially perpendicular to the upper wall and defines central circular opening. A passage extends from a lateral opening in the upper wall. A generally cylindrical lower wall extends from the radial shoulder substantially coaxial to the upper wall. The lower wall defines a lower bore with a diameter D₂ that is 80% or less of D₁. The lower wall is configured for insertion into the discharge hole of a flush tank. The upper and lower bores are fluidly connected via the circular opening and collectively define a discharge conduit. The lower wall can be inserted into the discharge hole of a flush tank to create a fluid tight seal between the tank and the discharge conduit. A generally circular flapper has a projection configured for swingable attachment to the outer surface of the valve assembly. The outer radial edge of the flapper extends radially beyond the upper wall. The flapper is configured to abut the upper wall at the inlet in a fluid tight seal when in a closed position. With application of a force F on the flapper in the direction away from the inlet, the flapper can swing between a closed position abutting the inlet and an open position raised from the inlet. The abutment of the flapper and the upper wall in the closed position fluidly seals the tank from the discharge conduit. The raised position allows fluid communication between the tank and the discharge conduit.

In yet another embodiment, a method of increasing the rate of flow of a fluid out of a flush tank through a discharge hole is disclosed. A flush valve assembly defining a discharge conduit is selected. The flush valve assembly has an upper portion with a generally cylindrical upper wall. The upper wall defines an upper bore with a diameter D₁ and an inlet with a sloped open face. A passage extends from a lateral opening in the upper wall. A radial shoulder extends inwardly from the upper wall opposite the inlet and defines a transition opening. A lower portion has a generally cylindrical lower wall that extends from the transition opening. The lower wall defines a lower bore with a diameter D₂ that is less than D₁ and an outlet. The lower wall is substantially coaxial to the upper wall and is configured for insertion into the discharge hole of a flush tank. The lower portion of the flush valve assembly is inserted into the discharge hole of a flush tank, creating a fluid tight seal between the tank and the discharge conduit. A generally circular flapper is attached to the assembly such that the flapper can swing relative thereto. The flapper is positioned in a closed position abutting the upper wall at the inlet in a fluid tight seal. The flush tank is filled at least partially with a fluid. The flapper is swung from the closed position to a raised opened position via application of a force on the flapper in the direction away from the inlet.

### BRIEF DESCRIPTION OF THE DRAWING

Aspects of the preferred embodiment will be described in reference to the Drawing, where like numerals reflect like elements:

FIG. 1 is a partial longitudinal section view of a flush valve assembly according to a preferred embodiment;

FIG. 2 is a partial longitudinal section view of the flush valve assembly of FIG. 1 showing the attached flapper in the opened position raised from the inlet;

FIG. 3 is a side view of another embodiment of the disclosed flush valve assembly during installation into the discharge hole of a flush tank; and

FIG. 4 is a longitudinal section view of the flush valve assembly of FIGS. 1 and 2 prior to engagement with a flapper and overflow tube.

### DETAILED DESCRIPTION OF THE PREFERRED EMBODIMENT

With reference to the drawing wherein like numerals represent like parts throughout the Figures, a flush valve assembly and a corresponding method of increasing the rate of flow of a fluid out of a flush tank with a discharge hole (i.e., a traditional toilet bowl tank) are disclosed. Embodiments allow installers to use a single piece to install or replace tank valves in tanks to achieve an increased flow rate out of tanks having relatively small discharge hole sizes.

In a preferred embodiment, the flush valve assembly 10 has an upper portion 12 and a lower portion 14. The upper portion 12 has a generally cylindrical upper wall 16 and an inwardly extending lower radial shoulder 18. The upper wall 16 defines an upper bore 17 with a diameter D₁ and has a sloped opened face that defines an inlet 20. As depicted, the inlet 20 slopes from a high edge 21 to a low edge 23 of the upper wall 16. A passage 22 extends from a lateral opening 24 in the upper wall 16. In the depicted embodiment, the passage 22 is generally L-shaped and has an open upper end 38 configured for engagement with an adjustable overflow tube 40 or similar component.

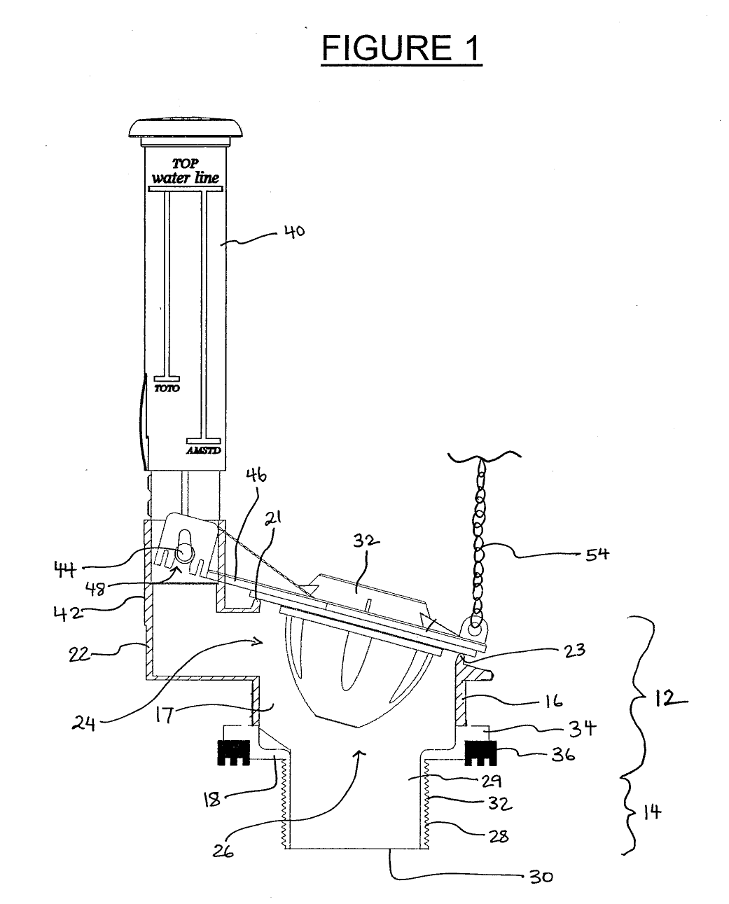

As depicted in FIG. 1, the radial shoulder 18 defines a transition opening 26 having a smaller diameter than the upper bore 17. The lower portion 14 comprises a generally cylindrical lower wall 28 that is configured for insertion into the discharge hole of a flush tank. The lower wall 28 extends from the transition opening 26 substantially coaxial to the upper wall 16. The substantially coaxial arrangement depicted in this embodiment is not limiting. As shown in FIG. 1, the lower wall 28 defines a lower bore 29 with a diameter D₂ and an outlet 30. Here, the lower wall 28 has a threaded outer surface 32 to assist with insertion and engagement with the discharge hole.

As shown, the upper and lower bores, 17 and 29, are fluidly connected via the transition opening 26. The fluidly connected upper and lower bores, 17 and 29, collectively define a discharge conduit that extends from the inlet 20 to the outlet 30.

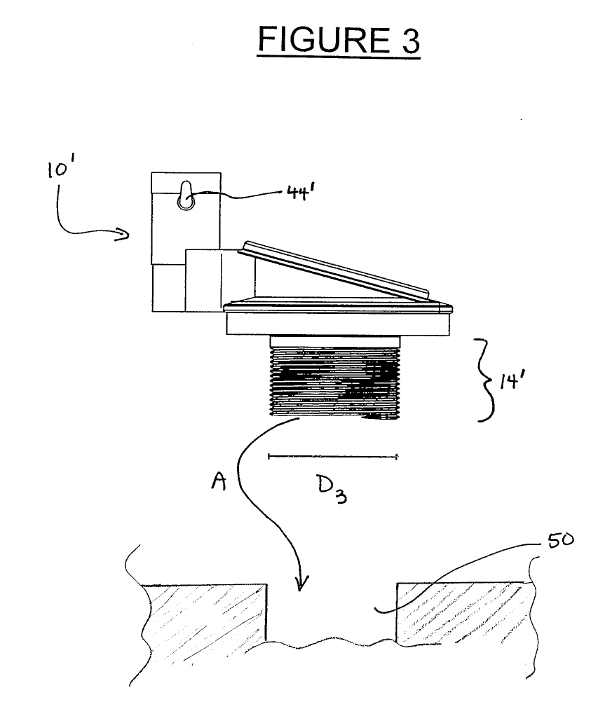

This particular embodiment of the flush valve assembly 10 includes a radial projection 34 extending from the outer surface of the upper wall 16. A ring-like sealing member 36 is positioned generally around the radial shoulder 18 abutting the lower surface of the projection 34. The sealing member 36 assists in creating a fluid tight connection between the flush tank and the discharge conduit. Alternatively, a smaller sealing member can be positioned around the lower wall 28 abutting the lower surface of the radial shoulder 18. Another alternative depicted in FIG. 3 does not include a radial projection or sealing member.

As noted above, this embodiment has an L-shaped passage 22 extending from a lateral opening 24 in the upper wall 14 generally below the high edge 21 of the inlet 20. The upper end 38 of the L-shaped passage 22 is configured for engagement with an adjustable overflow tube 40 or like component. The L-shaped passage has an outer surface 42 that is configured for swingable attachment to a generally circular flapper 32. This embodiment features substantially identical projections 44 positioned on opposite lateral sides of the L-shaped passage 22 (second projection 44 not shown). However, the attachment of a flapper is not limited in this way.

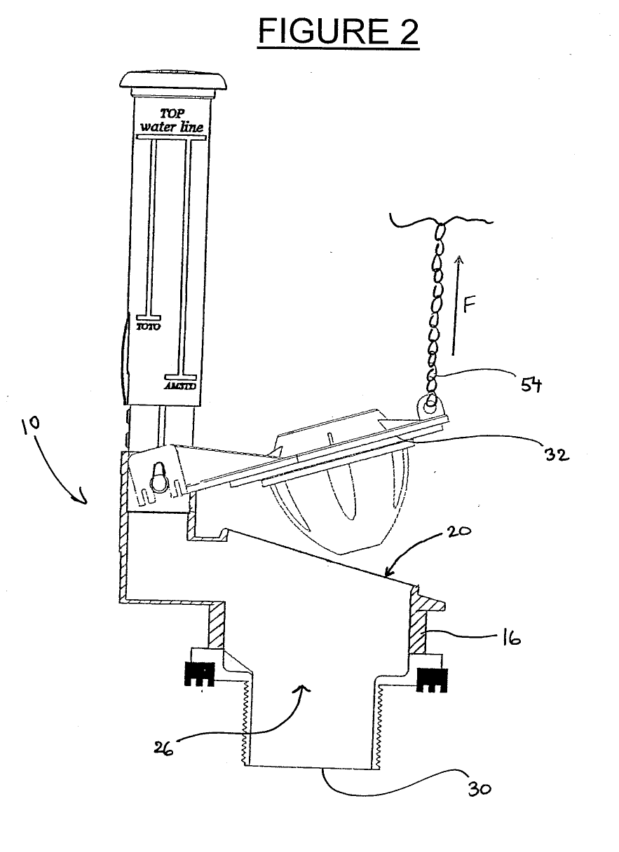

The flapper 32 may be included in a “kit” with the flush valve assembly 10 or may be a conventional commercially available flush valve flapper suitable for swingable attachment to the assembly. As can be seen in FIGS. 1 and 2, this flapper 32 has an arm 46 fit with notches 48 positioned to engage the opposite projections 44 on the passage 22. Preferably, the outer radial edge of the flapper extends radially beyond the upper wall 14.

One typical type of flush tank has a discharge hole with an approximately two inch diameter. Two inch discharge holes are smaller than other common sizes, and thus the rate of discharge flow is generally slower. An embodiment of the flush valve assembly 10 is configured especially for engagement with a two inch discharge hole and configured to effect an increase in flow rate.

As depicted in the embodiment of FIG. 3, the lower portion 14′ of the valve assembly 10′, having an outer diameter of D₃, is inserted relatively flushly into the similarly sized discharge hole 50. As shown, the valve assembly 10′ has projections 44′ to assist attachment of a flapper like that depicted as Reference Numeral 32 in FIGS. 1 and 2. The flapper and/or additional parts can be attached at any time before or after insertion into the discharge hole.

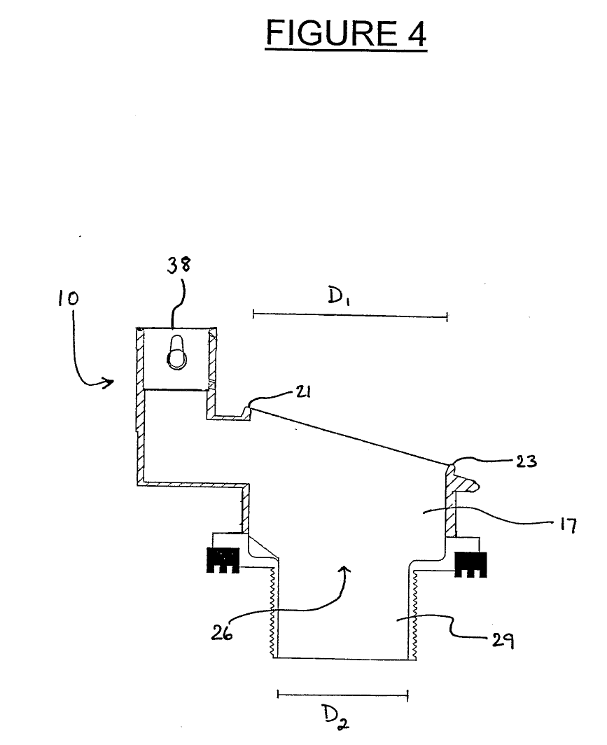

Though not shown in the Figures, the embodiment of FIGS. 1, 2 and 4 is installed in the same manner. In this embodiment, the sealing member or washer 36 is positioned to assist in creating a fluid tight connection between the tank 52 and the discharge conduit. Further, an installer can apply a downward force on the radial projection 34 or use the projection 34 to rotate the assembly 10 to further tighten the seal or align the assembly 10 as preferred.

In the embodiment depicted in FIGS. 1 and 2, a chain 54 is attached to the flapper 32. In FIG. 1, the chain 54 is shown in a relaxed position, with the flapper 32 abutting the inlet edge of the upper wall 16. This is the “closed position” of the flapper 32. The flapper 32 is generally made of a plastic or rubber material suitable for creating a fluid tight seal with the inlet edge when in the closed position. As shown in FIG. 2, the flapper 32 is swingable relative to the assembly 10 via application of a force F in the direction away from the main body fitting.

In common toilet tank configurations, the chain 54 depends from a flush rod that extends from a lever (not pictured). Opposite the flush rod, the chain 54 is attached to the flapper 32. When the lever is depressed, the rod pulls the chain 54 upwards and applies a force F on the flapper 32. It is noteworthy that the disclosed embodiments are not limited to the described lever-chain-flapper configuration. Other known means for applying a force on the flapper in the direction away from the inlet can be implemented.

As depicted in FIG. 2, application of the force F swings the flapper 32 to a raised position away from the inlet 20, thus opening the inlet 20 and allowing fluid communication between the interior of the tank and the outlet 30 through the discharge conduit. This fluid communication causes the water in the tank to discharge through the conduit and the toilet to flush. As the tank empties, the flapper 36 returns to the closed position abutting the inlet edge of the upper wall 14 to reseal the valve assembly 10.

Due to the discharge conduit having an upper bore 17 with a larger diameter (D₁) than the lower bore 29 (D₂), fluid discharges from the tank at a faster rate than it would through an opening with a diameter substantially equal to D₂. Thus, installing the valve assembly 10 depicted in the Figures into a tank with an approximately two inch discharge hole will result in increased flow due to the wider inlet 20 and upper bore 17. In a preferred embodiment, the lower wall 28 is configured for insertion into a discharge hole with an approximately two inch diameter and the upper bore diameter D₁ is approximately 125-175% of the lower bore diameter D₂. D₁ is approximately 150% of D₂ in yet another preferred embodiment. While the disclosed embodiments generally concentrate on a conventional tank with a two inch discharge hole, embodiments are not limited as such.

The assembly 10 can comprise a single moulded piece of rigid, resilient material, such as plastic, or multiple individual components joined together by welding, soldering, adhesive or the like. Further, the assembly 10 can come packaged alone or in a kit including an overflow tube and/or other pieces for incorporation into the valve assembly system. Likewise, a similar kit can include a flapper similar to that depicted as Reference Numeral 36.

As described herein, the disclosed embodiments of the flush valve assembly 10 enable increased flow to be achieved out of flush tanks, thus increasing the flush effectiveness and reducing the likelihood of plumbing blockage while keeping the volume of fluid discharged constant.

While a preferred embodiment has been set forth for purposes of illustration, the foregoing description should not be deemed a limitation of the invention herein. Accordingly, various modifications, adaptations and alternatives may occur to one skilled in the art without departing from the spirit of the invention and scope of the claimed coverage.

1. A flush valve assembly for use in a flush tank having a substantially cylindrical discharge hole, comprising:
an upper portion having
a generally cylindrical upper wall defining an upper bore having a diameter D₁ and an inlet with a sloped open face,
a lateral opening in the upper wall,
a generally L-shaped passage extending from the lateral opening in the upper wall; and
an inwardly extending lower radial shoulder defining a substantially circular transition opening opposite the inlet;
a lower portion having a generally cylindrical lower wall sized to mate with a discharge hole extending from the transition opening substantially coaxial to the upper wall, the lower wall defining a lower bore with a diameter D₂ that is less than D₁ and an outlet, the upper and lower bores being fluidly connected through said transition opening and collectively defining a discharge conduit.

2. The flush valve assembly of claim 1, wherein a generally circular flapper is configured to abut said upper wall at the inlet, the flapper having a projection configured for swingable attachment to the outer surface of said L-shaped passage, the outer radial edge of said flapper extending radially beyond said upper wall, the lower portion is inserted into a substantially cylindrical discharge hole of the flush tank creating a fluid tight seal between the tank and the discharge conduit, and said flapper is swingable relative to said L-shaped passage from a closed position abutting the upper wall at the inlet to an open position raised from the inlet by application of a force F on said flapper in the direction away from said inlet, the abutment of said flapper and said cylindrical wall in the closed position fluidly sealing the tank from the outlet and said raised position allowing fluid communication between said tank and said outlet through said fluid conduit.

3. The flush valve assembly of claim 1, wherein D₁ is approximately 125-175% of D₂.

4. The flush valve assembly of claim 1, wherein D₁ is about 2.75 to about 3.25 inches and D₂ is about 1.75 to about 2.25 inches.

5. The flush valve assembly of claim 1, wherein the upper and lower cylindrical walls, shoulder and passage comprise a single moulded member.

6. The flush valve assembly of claim 1, comprising a ring-like sealing member positioned around the lower portion abutting the radial shoulder to assist in creating fluid tight seal between the tank and the discharge conduit.

7. The flush valve assembly of claim 1, comprising a rigid radial projection extending from the outer surface of the upper wall.

8. The flush valve assembly of claim 7, wherein the radial projection is octagonal.

9. The flush valve assembly of claim 7, comprising a ring-like sealing member positioned around the radial shoulder abutting the radial projection to assist in creating a fluid tight seal between the tank and the discharge conduit.

10. The flush valve assembly of claim 1, wherein the lower cylindrical wall has a threaded outer surface.

11. The flush valve assembly of claim 1, wherein the radial shoulder is substantially perpendicular to the upper and lower cylindrical walls.

12. The flush valve assembly of claim 2, wherein when the flush tank is at least partially filled with a fluid with the stopper in the closed position and the stopper is subsequently moved from the closed position to the raised opened position, said fluid expels from the tank through said discharge conduit in with a substantially vortex-like flow.

13. A flush valve assembly for use in a flush tank having a discharge hole with an approximately two inch diameter, comprising:
a generally cylindrical upper wall defining an upper bore having a diameter D₁ and an inlet with a sloped open face;
a substantially perpendicular lower radial shoulder defining a central transition opening extending inwardly from the upper wall opposite the inlet;
a lateral opening in the upper wall;
a lateral passage extending from the lateral opening in the upper wall;
a generally cylindrical lower wall extending from the radial shoulder substantially coaxial to the upper wall defining a lower bore with a diameter D₂ that is 80% or less of D₁ and being configured for insertion into said discharge hole, the upper and lower bores being fluidly connected via the transition opening and collectively defining a discharge conduit; wherein
a generally circular flapper is configured to abut said upper wall at the inlet, the flapper having a projection configured for swingable attachment to the outer surface of the flush valve assembly, the outer radial edge of said flapper extending radially beyond said upper wall, the lower wall is inserted into the substantially cylindrical discharge hole of the flush tank creating a fluid tight seal between the tank and the discharge conduit, and said flapper is swingable relative to said assembly from a closed position abutting the upper wall at the inlet to an open position raised from the inlet by application of a force F on said flapper in the direction away from said inlet, the abutment of said flapper and said upper wall in the closed position fluidly sealing the tank from the discharge conduit and said raised position allowing fluid communication between said tank and said discharge conduit.

14. The flush valve assembly of claim 13, comprising a ring-like sealing member positioned around the lower wall abutting the radial shoulder to assist in creating fluid tight seal between the tank and the discharge conduit.

15. The flush valve assembly of claim 13, comprising a rigid radial projection extending from the outer surface of the upper wall.

16. The flush valve assembly of claim 15, comprising a ring-like sealing member positioned around the radial shoulder abutting the radial projection to assist in creating a fluid tight seal between the tank and the discharge conduit.

17. The flush valve assembly of claim 13, wherein the lower cylindrical wall has a threaded outer surface.

18. A method of increasing the rate of flow of a fluid out of a flush tank through a substantially cylindrical discharge hole, comprising:
(a) selecting a flush valve assembly defining a discharge conduit and comprising
an upper portion having a generally cylindrical upper wall defining a upper bore having a diameter D₁ and an inlet with a sloped open face, a passage extending from a lateral opening in the upper wall, an inwardly extending lower radial shoulder defining a transition opening opposite the inlet,
a lower portion having a generally cylindrical lower wall extending from the transition opening and defining a lower bore with a diameter D₂ that is less than D₁ and an outlet, the lower wall being substantially coaxial with the upper wall and configured for insertion into the discharge hole;
(b) inserting the lower portion of the flush valve assembly into the discharge hole, thereby creating a substantially fluid tight seal between the tank and the discharge conduit;
(c) attaching a generally circular flapper to the flush valve assembly, the flapper being configured to swing relative thereto;
(d) positioning said flapper in a closed position abutting the upper wall at the inlet in a fluid tight seal;
(e) filling said flush tank at least partially with a fluid; and
(e) swinging said flapper from the closed position to a raised opened position via application of a force on the flapper in the direction away from the inlet.

19. The method of claim 18, wherein said fluid expels from said tank through the outlet in a vortex when said flapper is swung to the opened position.

20. The method of claim 18, wherein the flapper returns to the closed position by gravitational forces after the fluid within the tank reaches a predetermined volume level.
